(19) United States
(12) Patent Application Publication
(10) Pub. No.: US 2018/0189602 A1
(43) Pub. Date: Jul. 5, 2018

(54) METHOD OF AND SYSTEM FOR DETERMINING AND SELECTING MEDIA REPRESENTING EVENT DIVERSITY

(71) Applicant: THOMSON LICENSING, Issy les Moulineaux (FR)

(72) Inventors: Pierre HELLIER, Thorigné Fouillard (FR); Fabrice URBAN, Thorigne Fouillard (FR); Patrick PEREZ, Rennes (FR)

(21) Appl. No.: 15/315,590

(22) PCT Filed: Jun. 1, 2015
(86) PCT No.: PCT/EP2015/062081

§ 371 Date: Dec. 1, 2016

(30) Foreign Application Priority Data
Jun. 3, 2014 (EP) 14305843.6

(51) Int. Cl. G06K 9/62; G06K 9/00; G06T 7/00; G06K 9/20; G06F 17/30

(52) U.S. Cl. CPC G06K 9/6221; G06K 9/00677; G06K 2209/27; G06K 9/2081; G06F 17/3028; G06T 7/97

(57) ABSTRACT

A method of reducing a large amount of media into a sub-group of high quality images in order to capture the diversity of an event. The present invention teaches a method of reducing a plurality of media into clusters in response to time and place. The clusters are further reduced in response to content in said media, including color and facial recognition to transmit still generate highlights. Near duplicate images are then removed from each highlight and then a high quality image is selected from each highlight. The high quality image is selected from each highlight and combined into an event overview to represent the diversity of an event.

### FIELD OF THE INVENTION

The invention relates to a method of and a system for determining and selecting high quality images and media representing and capturing the diversity of an event.

### BACKGROUND

Today's smartphones and similar devices can be used to obtain almost any information about almost any object, or person for that matter, in almost any place at almost any time. However, such information retrieval can be cumbersome for a user, as the typical way of accessing information is through a search engine using an internet browser. The search request needs to be entered manually, and search keywords may not be correctly describing the object about which a user is trying to obtain information. Any event filmed by a user, such as personal media generated during holidays, family events, sporting events, weddings, etc can generate an unwieldy amount of content.

It would be desirable for a system to select a subset of images and media content automatically from this mass of content in order to summarize the event. Selectively reducing the amount of content can permit a user or viewer to better visualize and exploit the content in order to quickly represent an event. However, the subset of content must be chosen carefully, sampling the timeline of the event, eliminating redundant images and content, representing the color diversity of the event and choosing the best images in terms of quality.

### SUMMARY OF THE INVENTION

According to an exemplary aspect of the invention, a method of determining a subset of media comprising clustering a plurality of media into events in response to metadata associated with each of said plurality of media to generate a plurality of event clusters, subclustering each of said plurality of event clusters into a plurality of subclusters in response to content within the media and metadata associated with said media to generate a plurality of subclusters, color clustering each of said subclusters in response to a predominant color within said media to generate a plurality of color clusters, and deleting at least one near duplicate image from at least one of said plurality of color clusters.

According to another exemplary aspect of the invention, an apparatus comprising a memory for storing a plurality of images, a processor for sorting the plurality of images into a first group of images and a second group of images in response to metadata associated with each of said plurality of images, sorting said first group of images into a third group of images and a fourth group of images in response to a media attribute of each of said plurality of images within said first group of images, and generating a list of images, wherein said list of images includes a first image from said third group of images and a second images and a second image from said fourth group of images, and a display for displaying said first image and said second image, wherein said first image represents said third group of images and said second image represents said fourth group of images.

According to another exemplary aspect of the invention, the media is selected in response to the interest value each image, ranging from saliency, visual quality, aesthetic value of the image, with may be computed using any available metric, from the simplest derived from contrast, sharpness or blur measure, to a more complex using machine learning techniques, as well as image memorability.

### BRIEF DESCRIPTION OF THE DRAWINGS

The invention will now be described with reference to the attached drawing, in which

FIG. 1 shows an exemplary photograph of an object and the location of the user input as taken in accordance with the present invention;

FIG. 2 shows a simplified view of the rear side of a camera implementing the invention;

FIG. 3 shows a flow diagram of the method in accordance with an embodiment the invention;

FIG. 4 shows details of a flow diagram of the method in accordance with a further embodiment of the invention;

FIG. 5 shows a block diagram of a device in accordance with one aspect of the invention; and

FIG. 6 shows a block diagram of a device in accordance with a further aspect of the invention.

FIG. 7 shows an exemplary selection of media selected according with a further aspect of the invention.

In the figures, like elements are referenced with the same reference designators.

### DETAILED DESCRIPTION OF EMBODIMENTS

In one embodiment of the invention a mobile communication device provided with camera functionality serves as hardware basis to implement the method according to the present invention.

FIG. 1 shows an exemplary still image of an object and the location of the user input as taken in accordance with the present invention. The still image shows a film poster, 102, along with other objects, 104, 106. Oval spot 108 represents a location where a user has touched the live image on a touch screen, in response to which touch the still image was taken. The touch input can be replaced through other kinds of user interaction in case a touch screen is not available. Other suitable ways of providing the user input include a cursor or other mark that is moved across the screen, for example by means of corresponding directional cursor keys, a trackball, a mouse, or any other pointing device, and that is positioned over the object. Oval spot 108 is located on film poster 102. The location information is used for singling out film poster 102 from the other objects present on the still image. Location can be given in terms of pixels in x and y direction from a predetermined origin, or in terms of ratio with regard to the image width and height, or in other ways. An object identification process uses the location information for determining the most probable single object in relation to the location of the user input. In the present example this is relatively simple, as the object has well defined borders and distinguishes well from the background. However, advanced object recognition is capable of singling out objects having more irregular shapes and having less defined borders with respect to the background. For example, a Gaussian radial model is used for extracting points of interest in relation to the location of the user interaction, wherein more points of interest are extracted closer to the exact location of the user interaction, and lesser and lesser points are extracted with increasing distance to the exact location of the user interaction. This greatly improves robustness of the object identification and recognition. Depending on the implementation of the invention some part of the process of singling out an object can be performed on a user's device, while a remaining part is performed on a connected remote device. Such load sharing reduces the amount of data that needs to be transmitted, and can also speed up the entire process.

In a development the location of user input is highlighted prior to identifying the object using the still image and the user input location data, or prior to sending the image and corresponding user input location data to an information providing device. In a further development a user conformation confirming the user input location is required prior object identification.

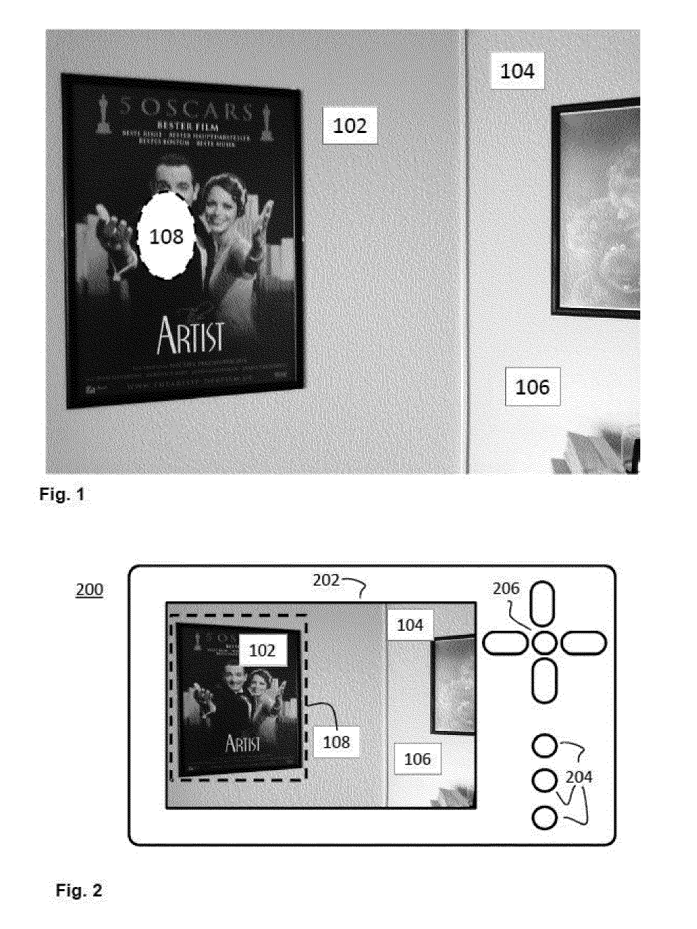

In a variant of the invention the location of an object of interest to the user is provided through circling the object on the screen, or through a gesture that is akin to the pinch-to-zoom operation on modern smartphones and tablets. Such two-finger gesture can be used for opening a square bounding box that a user adjusts to entirely fit the object of interest, for example as shown by the dashed square box 108 surrounding film poster 102 in FIG. 2. This user defined bounding box will greatly enhance the object recognition process, and can also be used for cropping the image prior to object identification and recognition. In case the object identification and recognition is performed remotely to the user device, cropping decreases the amount of data to be transmitted through reducing the size of the still image to be transmitted.

Also, as discussed further above, in one embodiment of the invention the location of the user input is used for focusing the camera lens to that specific part of the image prior capturing the still image.

FIG. 2 shows a simplified view of the rear side of a camera 200 including a display screen 202, an arrangement of cursor control buttons 206 and further control buttons 204. The image shown on the display screen corresponds to the image of FIG. 1, and the reference designators in the image are the same. Film poster 102 is surrounded by a square box, 108, indicating the object of interest. In one embodiment the square box is placed and sized using the arrangement of cursor control buttons 206. It is, however, also conceivable to size and place the box using the pinch-to-zoom-like gesture discussed further above.

In other embodiments of the invention the object of interest is marked through non-touch gestures, e.g. a finger or any other pointing device floating over the object represented on the screen or in front of the lens. It is also conceivable to use eye-tracking techniques for marking an object of interest to a user.

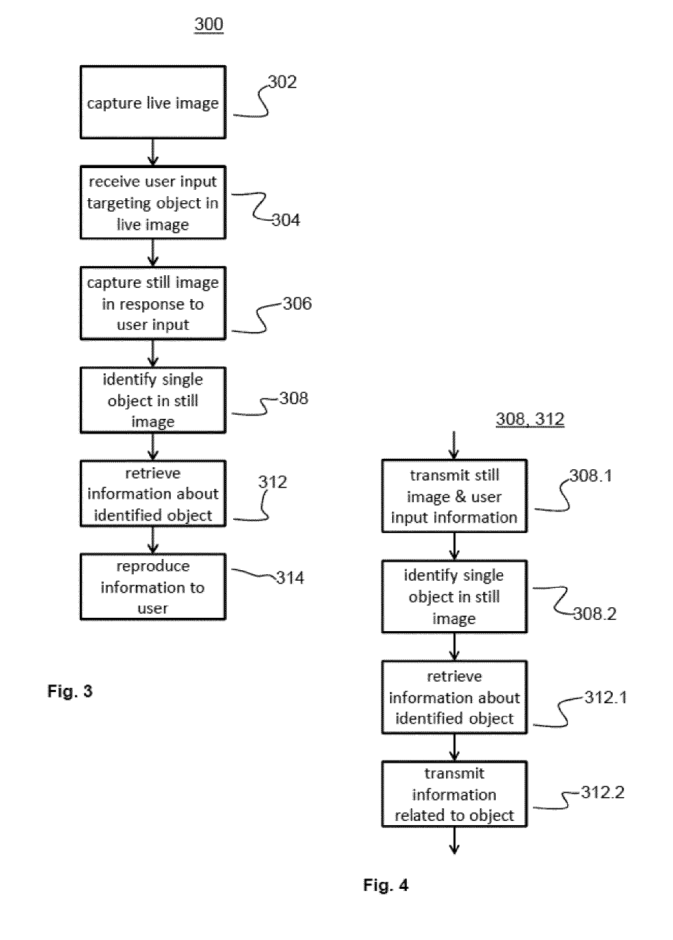

FIG. 3 shows a flow diagram of the method in accordance with an embodiment of the invention. The first step of flow 300 is capturing a live image of whatever scene a user wishes to obtain information about, or, more particular, of a scene including an object about which a user desires to obtain information, step 302. Once the live image shows the object that is of interest to the user, the user provides an input on the screen targeting the object, step 304. This input is for example a user's finger touching the screen at the location where the object is shown, as described further above. Once the user input targeting the object is completed, a still image is captured in response, step 306. In a development the user input is additionally be used for focusing that part of the image corresponding to the location of the object, in an otherwise known manner. The focusing aspect is generally applicable to all embodiments described in this specification.

The object in the still image targeted by the user input is identified or recognized in step 308. Then, information about the identified or recognized object is retrieved, step 312. Information retrieval is for example accomplished through a corresponding web search, or, more general, a corresponding database search using descriptors relating to the object and obtained in the identification or recognition stage. In one embodiment the database is provided in the user device that executes the method, or is accessible through a wired or wireless data connection. In one embodiment object identification includes local feature descriptors and/or matching the object in the still image with objects from a database.

The information retrieved is provided to the user and reproduced in a user-perceptible way, step 314, including but not limited to reproducing textual information on the screen or playing back audio and/or video information.

In one embodiment of the invention the identification step 308 and the image retrieval step 312 are performed by a device remote from a user device that runs a part of the method. This embodiment is described with reference to FIG. 4. In step 308.1 the still image and information about the location of the user input is transmitted to an information providing device that performs identification of the object a user wishes to obtain information about, step 308.2. Then, step 312.1, the information providing device retrieves information about the object previously identified. Information retrieval is done in the same way as described with reference to FIG. 3. The information about the object obtained in the previous step is then transmitted, step 312.2, to the user device, for further processing, reproduction, etc., for example as described with reference to FIG. 3.

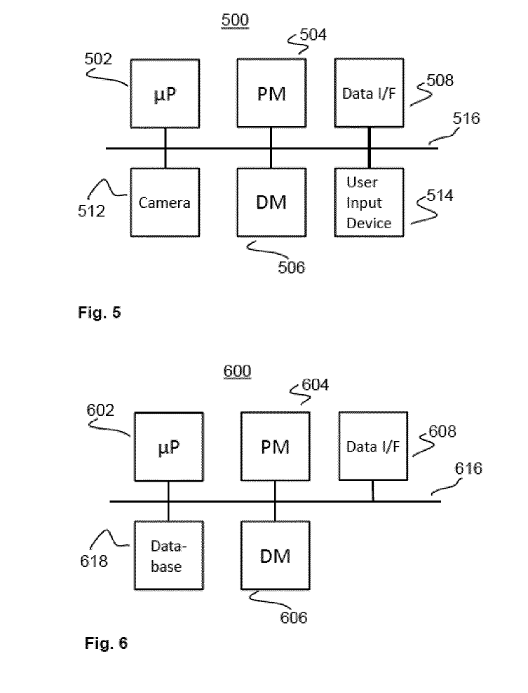

FIG. 5 shows a block diagram of a user device 500 in accordance with the invention. Microprocessor 502 is operationally connected with program memory 504, data memory 506, data interface 508, camera 512 and user input device 514 via bus connection 516. Bus connection 516 can be a single bus, or a bus system that suitably splits connections between a plurality of buses. Data interface 508 can be of the wired or wireless type, e.g. a local area network, or LAN, or a wireless local area network, or WLAN. Other kinds of networks are also conceivable. Data memory 506 holds data that is required during execution of the method in accordance with the invention and/or holds object reference data required for object identification or recognition. In one embodiment data memory 506 represents a database that is remote to user device 500. Such variation is within the capability of a skilled person, and is therefore not explicitly shown in this or other figures. Program memory 504 holds software instructions for executing the method in accordance with the present invention as described in this specification and in the claims.

FIG. 6 shows a block diagram of an information providing device 600 in accordance with the invention. Microprocessor 602 is operationally connected with program memory 604, data memory 606, data interface 608 and data base 618 via bus connection 616. Bus connection 616 can be a single bus, or a bus system that suitably splits connections between a number of buses. Data interface 608 can be of the wired or wireless type, e.g. a local area network, or LAN, or a wireless local area network, or WLAN. Other kinds of networks are also conceivable. Data memory 606 holds data that is required during execution of the method in accordance with the invention and/or holds object reference data required for object identification or recognition. Data base 618 represents a database attached to information providing device 600 or a general access to a web-based collection of databases. Program memory 604 holds software instructions for executing the method in accordance with the present invention as described in this specification and in the claims.

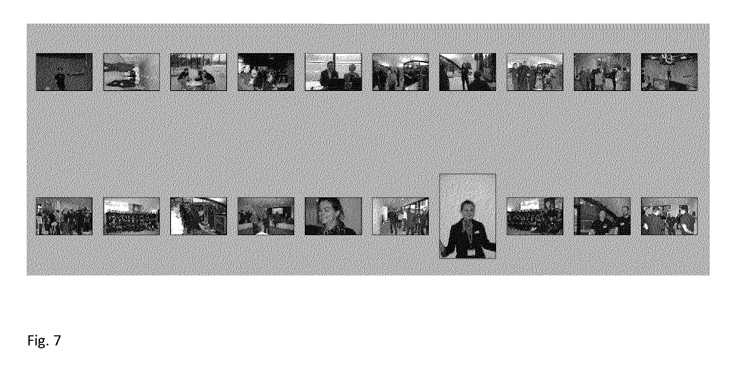

FIG. 7 shows an exemplary selection of media selected according with a further aspect of the invention. The images shown in the cluster of FIG. 7 illustrate media selected according to the following method.

To address the problem, the proposed system teaches to organize the image database, detect duplicates and perform an adapted k-medoid clustering. The following steps (data organization, data pruning and data selection) are performed:
1—Database organization: Time and color clustering, near-duplicate detection Considering a database of n images (n being potentially large, ranging from few hundred to several tens of thousands), an organization step is performed first. The two expected benefits are the following:
   a—It serves as a pre-processing to the near duplicate detection, as explained after;
   b—It enables a more rapid and convenient visualization to the user.
      Event clustering
         Considering that the database may contain all the images of a user, let's say from 2011 to 2014, it is first needed to split the database into events given a time descriptor and location (GPS coordinates, if available), computed using the EXIF data extracted from the image files. The latter can be for instance the number of days between Jan. 1, 2000 and the acquisition date.
         As an output, events are hopefully separated, for instance Trip to Southern France in August 2011 and wedding of cousin John in Paris in October 2011. It is desired to extract the best moments for each extracted event.
      Sub-event time clustering
         Once the events are clustered, a sub-event clustering is necessary to organize the group of pictures among which some will be selected as a summary. The sub-event, can be roughly defined as a scene containing a given group of people with a tight unity of time and space.
         Such a time clustering (e.g., for a wedding the clustering shall split the church ceremony from the night party) can be easily performed using a time descriptor extracted, for each image, from the EXIF data. Any one of a number of clustering techniques can be used here.
      Color clustering
         For each time cluster, a color clustering is performed to group the images into sets of visually consistent images. This process can be performed as follows: for each image, a vector representing the proportion of colors on a known dictionary.
      Deal with near duplicate
         Once the images of an event have been organized in groups of coherent images (temporal and color clusters), a detection of near duplicates (images of extremely similar content, typically several shots of the same scene taken at almost the same instant) is performed in a classical and brute-force manner:
         For a cluster of k images, and for each pair of images:
            1. Detect key points on the two images using HOG, FAST, or SURF;
            2. Describe these points using a local descriptors either gradient-based (such as SIFT) or binary (such as BRIEF);
            3. Match these key points, i.e., for each key point in first image, compute the closest key point in terms of descriptor, in second image;
            4. Compute an homography (perspective transform) between the two images using this set of correspondences;
            5. Compute the ratio of correspondences that are compliant to the estimated homography;
            6. If the ratio is greater than a given threshold (for instance, 50%), consider this pair of images to be a near-duplicate.
         Since the computation of near duplicates is of complexity O(k²), the benefit of performing temporal and color clustering can be understood: it is only relevant to spend computation time for a set of coherent images. In addition, the threshold can be made more strict, limiting the risk of false negative detection.
2—Database pruning: merge near-duplicate into clusters with aggregated quality scores
   Once the near duplicate detection has been performed, the media tree will be pruned to merge duplicate images. In other words, images belonging to a near-duplicate cluster will be replaced by only one image, with the following steps:
      A representing image is computed, for instance as the iconoid image. As a secondary scenario, the iconoid image may just be the image of that cluster having the highest quality.
      The quality score of the iconoid image aggregates (e.g., sums) the quality score of each image in the cluster.
   The pruning step aims at keeping only one image per near-duplicate cluster, with a high quality score so that it will be selected with a higher probability by the selection algorithm.
3—Database selection: image distance computation and quality adapted k-medoid clustering
   After the pruning step, a selection step is necessary to extract p “best” images from the database. The selection can be viewed as a k-medoid clustering step, adapted to account for the image quality.
   As an offline preprocessing, dissimilarity Dᵢⱼ is computed between each image pair (Xᵢ,Xⱼ): a color distance is computed (many distances are possible, the EMD distance [Rubner00] between two color vectors previously extracted has been implemented and tested). In addition, a temporal distance is also computed, as the time difference in minutes between two images.
   The final distance is a weighted average of the two distances after normalization between 0 and 1.
   Extracting the p best images can be posed as the joined problem of clustering the set of images into p new clusters and select one iconoid image per cluster. The following joint minimization problem may be used to address such a problem:

$${ }_{{C}_{i , p ,}} {min}_{{[ j * ( i ) ]}_{i ∈ [ 1 , p ]}} {\sum }_{i = 1}^{p} {\sum }_{j \vert {X}_{j} ∈ {C}_{i}} {\vert {D}_{j , j} {*}_{( i )} \vert}^{2} + f ( {q}_{j} {*}_{( i )} )$$

Where qᵢ is the quality score of the i^{th} image, {j*(i)}_{i∈[1,p]} is the list of the p medoids, one per cluster, and f is a decreasing function so that medoids are chosen to be of high quality. The last term departs from classical k-medoid algorithms.
The minimization of such a cost function can be done in an iterative manner, alternating between:
   For each image, assign the image to the cluster of the closest medoid;
   Once the clusters are estimated, and for each image of the cluster:
      Swap the role of the image and the medoid;
      Compute the cost function of this new configuration;
      Retain the image as the new medoid if the cost function decreases.

According to one embodiment of the invention the inventive method is implemented in a device that provides the user interface, captures the image and performs the object recognition. The database can be provided in the device, or can be located outside the device, accessible through a wired or wireless data connection.

In case the device cannot perform the object identification, according to one embodiment of the invention, the device transmits the captured image along with information about the location of the single user input on the screen relative to the live image reproduced on the screen, to an information providing device. Such device can be a server running an object recognition service that returns information related to the object. Such information includes, for example, search keywords that are automatically provided to a web browser in the user device, for initiating a corresponding web search. However, it is also conceivable that the information providing device provides results of a web or database search relating to the object to the user device. In an embodiment of the invention the expected type of response of the information providing device is user-configurable through a configuration menu or dialog in the user device.

An information providing device in accordance with the embodiment described before includes a processor, program and data memory, and a data interface for connecting to a user device and/or a database. The device is adapted to receive, from the user device, a still image showing at least the object as well as information about the location of a user input indicating the relative position of the object in the still image. The information providing device is further adapted to identify a single object in accordance with the received still image and supplementary data, and to retrieve, from a database, information related to the object. The information providing device is further adapted to transmit the information related to the object to the user device.

In a further embodiment of the invention, further data is used for identifying a single object, for retrieving information about the single object, or for both purposes. The further data includes a geographical position of the place where the still image was taken, or the time of day when the still image was taken, or any other supplementary data that can generally be used for improving object recognition and/or the relevance of data on the object. For example, if a user takes a still image of a movie poster while being in a town's cinema district, such information is useful for enhancing the object recognition as well as for filtering or prioritizing information relating to when the movie is played, and in which cinema.

In one embodiment, once the user is presented the results of the object recognition and/or the information related to the object, he/she is offered further options for interaction, e.g. select one or more items from a results list for subsequent reproduction, or making a purchase or booking relating to the object, e.g. buy a cinema ticket for a certain show. Other options include offering to show audiovisual content relating to the object, e.g. a film trailer in case the object was a film poster, or providing information about the closest cinema currently showing the movie on the film poster.

Generally, supplementary information or data relating to the object is provided in response to the object identification or recognition, including any kind of textual data, audio and/or video, or a combination thereof.

In one embodiment further contextual information is used for sorting the results provided in response to the object identification or recognition. For example, when the user is located in a city's cinema hotspot, a picture of a movie poster will produce information about when and where the movie is shown as first items on a list. In case a picture of an object in a museum is shot, information related with similar objects in museums can be prioritized for display. Also, object recognition is likely to be easier when the location is recognized as being inside a museum.

The invention advantageously simplifies the user interface and reduces the number of user interactions while providing desired information or options. In one embodiment a single touch interaction on a live image suffices to produce a plethora of supplementary information that is useful to a user. The invention can be used in many other contexts not related to cinemas and films. For example, applying the invention to art objects, e.g. street art or the like, will produce further information about the artist, or can indicate where to find more art objects from the same artist, from the same era, or of the same style. The invention is simply useful for easily obtaining information about almost any common object that can be photographed. The invention can also be implemented through a web-based service, enabling use of the method for connected user devices having limited computational capabilities.

1-30. (canceled)

31. A method of generating representative images from a plurality of images, comprising:
sorting a plurality of images to at least one cluster of images in response to metadata associated with each of the plurality of images;
for each cluster of images, sorting images in the cluster of image to at least one subcluster of images, wherein images in the subcluster have similar visual attributes; and
for each subcluster of images, using k-medoid algorithm with consideration of image quality to select one image from the subcluster of images as a representative image of the subcluster of images.

32. The method of claim 31 wherein the k-medoid algorithm is
$${ }_{{C}_{i , p ,}} {min}_{{[ j * ( i ) ]}_{i ∈ [ 1 , p ]}} {\sum }_{i = 1}^{p} {\sum }_{j \vert {X}_{j} ∈ {C}_{i}} {\vert {D}_{j , j} {*}_{( i )} \vert}^{2} + f ( {q}_{j} {*}_{( i )} )$$
D_{j,j*(i)} is a dissimilarity between an image pair
Q_{j*(i)} is a quality score of j*(i) image
{j*(i)}_{i∈[1,n]} is a list of the p medoids, one per subcluster, and
f is a decreasing function.

33. An apparatus of generating representative images from a plurality of images comprising:
a memory for storing the plurality of images;
a processor for sorting the plurality of images into at least one cluster of images in response to metadata associated with each of said plurality of images, for each cluster of images, sorting images in the cluster of image to at least one subcluster
of images, wherein images in the subcluster have similar visual attributes; and for each subcluster of images, using k-medoid algorithm with consideration of image quality to select one image from the subcluster of images as a representative image of the subcluster of images; and
a display for displaying the representative images.

34. The apparatus of claim 33 wherein
wherein the k-medoid algorithm is
$${ }_{{C}_{i , p ,}} {min}_{{[ j * ( i ) ]}_{i ∈ [ 1 , p ]}} {\sum }_{i = 1}^{p} {\sum }_{j \vert {X}_{j} ∈ {C}_{i}} {\vert {D}_{j , j} {*}_{( i )} \vert}^{2} + f ( {q}_{j} {*}_{( i )} )$$
D_{j,j*(i)} is a dissimilarity between an image pair
Q_{j*(i)} is a quality score of j*(i) image
{j*(i)}_{i∈[1,p]} is a list of the p medoids, one per subcluster, and
f is a decreasing function.
